(19) United States
(12) Patent Application Publication
(10) Pub. No.: US 2004/0224114 A1
(43) Pub. Date: Nov. 11, 2004

(54) Roofing system and tile

(76) Inventor: Kartik P. Patel, Chapel Hill, NC (US)

Correspondence Address: Womble Carlyle Sandridge & Rice, PLLC, P.O. Box 7037, Atlanta, GA, 30357-0037, US

(21) Appl. No.: 10/435,403

(22) Filed: May 9, 2003

(51) Int. Cl. B32B 9/00

(52) U.S. Cl. 428/40.1; 428/354; 428/61

(57) ABSTRACT

Disclosed is a roofing system for adhering two or more roofing tiles together to form a substantially impermeable barrier of a roof. Additionally disclosed is a roofing tile having a pre-applied adhesives strip and a method for forming a roof. The adhesive strip comprises a foamed polymer which in combination with an adhesive layer binds or seals the roofing tiles.

### TECHNICAL FIELD

The present invention generally relates to a roofing system and more specifically to a system including a foamed glass tile having a foamed adhesive strip attached to the tile for bonding multiple tiles.

### BACKGROUND

Built-up roofing (BUR) systems generally comprise a substantially rigid deck covered with a membrane comprising multiple layers of bitumen impregnated felt having a separately applied coating of bitumen on top of each layer of felt with a protective layer of small stones or other inert mineral aggregate materials embedded in and covering the top bitumen coating. BUR is used primarily on commercial buildings which have flat or low-slope roofing systems. Its popularity arises from its relatively low cost combined with its effectiveness as a water repellant membrane and its durability.

Bituminous materials, especially asphalt and coal tars, have been utilized as roofing materials particularly in built-up roofing applications, as road paving materials, and as adhesive materials. However, such materials tend to deteriorate under conditions of extreme temperature variations, constant exposure to physical stress, and environmental weathering.

Additionally, membranes of bituminous sheets or tiles can be attached by partially melting their undersurface to obtain adherence. However, the use of burners or similar heating apparatus can transmit flames, inflammable elements or loose material can give rise to the risk of burning during the application of the flame. Furthermore, there is a risk of burning after the work, by reaction of the combustion of the slowly combustible materials having been in contact with the flame, such as, for example, thermal insulating materials, often hidden and covered by other materials less sensitive to heat.

There also are, of course, known sealing sheets with cold self-adhesive undersurfaces, however, they are difficult to emplace from a standpoint of coming unfastened and do not give rise to sufficiently great adherence to supply an intimate surface contact and a securement that is resistant over time, especially on inclined or vertical surfaces.

There also exist liquid or viscous sealing products, particularly bitumen based, that can be applied easily with a spatula or a brush, particularly at places where the installation of sheets is difficult.

Nevertheless, these liquid or viscous products often have insufficient elasticity to resist without damage the movements or deformations of the support, an unstable sealing over the course of time, poor resistance to UV and, above all, insufficient adhesivity to ensure sufficiently intimate, resistant and durable fastening on different supports, particularly inclined or vertical supports.

### SUMMARY

The present invention comprises a roofing system built up of tiles adhered to each other to form a barrier layer or a roof. The roofing system includes at least a first roofing tile and a second roofing tile. An adhesive strip comprises a polymeric foam strip having a first side and a second side and an adhesive layer residing on the first and second sides. The adhesive strip bonds or seals the first and second roofing tiles together.

In greater detail, the roofing tile may comprise a foamed glass material and the adhesive may be a pressure sensitive adhesive or a hotmelt pressure sensitive adhesive. In an additional embodiment, the adhesive may include those that are non-bituminous. The polymeric foam strip may be formed from a foamed polymer comprising polyvinylchloride, acrylo nitrile butadiene rubber, styrene butadione rubber, and co-polymers of ethylene or propylene. Additionally, a release liner may be used in communication with the adhesive residing on the first and second sides.

An additional embodiment includes a roofing tile comprising an adhesive strip applied to the roofing tile. The adhesive strip includes a polymeric foam strip having a first side and a second side, and an adhesive residing on the first and second sides. The adhesive may be non-bitumen based. Additionally, the adhesive may be a pressure sensitive adhesive or a hotmelt pressure sensitive adhesive. The adhesives layer may include a release layer applied to one side of the strip. Again, the tile can be formed from a foamed glass.

A further embodiment includes a method of forming a roofing system. The method includes providing at least a first roofing tile and a second roofing tile and then adhering an adhesive strip to the first and second roofing tiles. The tiles can then be bonded together using the adhesive strip. The adhesive strip may comprise a polymeric foam strip having a first side and a second side. The adhesive may be a pressure sensitive adhesive or a hotmelt pressure sensitive adhesive. Additionally, in a further embodiment, the adhesive may be a non-bituminous adhesive applied to the first and second sides.

### DESCRIPTION OF THE DRAWINGS

In the drawings:

FIG. 1 illustrates the adhesive strip comprising a substrate and adhesive residing on two opposing sides of the substrate.

FIG. 2 illustrates the roofing tile having the adhesive strip applied to a tile.

FIG. 3 illustrates a plurality of roofing tiles forming a roofing system having the tiles adhered to each other by the adhesive strip.

### DETAILED DESCRIPTION

The present invention comprises a roofing system built up of tiles adhered to each other to form a barrier layer. The tiles 8 include shingles formed from most any material suitable for use as a roofing material. Preferably, the tiles 8 are formed from shingles or roofing membranes substantially free of asphalt. Typically, the tiles are formed from a foamed glass. The tiles 8 are bonded or sealed together using an adhesive strip 2 comprising a polymeric foam strip 4 having a first side and a second side and an adhesive layer 6 residing on the first and second sides.

A further embodiment includes a roofing tile 8 comprising an adhesive strip 2 applied to the roofing tile. The adhesive strip 2 includes a polymeric foam strip 4 attached to the roofing tile. Typically, the foamed strip 4 is adhered to the tile using any conventional adhesive such that the adhesive is capable of holding its integrity under the environmental conditions of a roof. The adhesive layer 6 may be non-bituminous, or a pressure sensitive adhesive or a hotmelt pressure sensitive adhesive. The adhesive layer 6 may include a release layer.

Additionally, a method is provided for forming a roofing system. The method includes providing at least a first roofing tile and a second roofing tile and then adhering an adhesive strip to the first and second roofing tile 8. The tiles 8 can then be bonded together or sealed using the adhesive strip 2. The adhesive strip 2 may comprise a polymeric foam strip 4 having a first side and a second side. The adhesive layer 6 may be a pressure sensitive adhesive and/or a hotmelt pressure sensitive adhesive or a non-bituminous adhesive applied to the first and second side.

Polymeric Foamed Polymer Strip

The foamed substrate strip 4 may be formed of most any polymeric material. Typically, the substrate 4 comprises a thermoplastic material or thermoplastic resin that softens and flows upon the application of pressure and heat. Thermoplastic resin foams typically have substantially closed-cell structures incorporating within the resin material a volatile organic liquid or blowing agent which vaporizes upon heating to form a gas. Alternatively, a foam can be used which is produced using a rubber/plastic blend which is chemically cross-linked and expanded using a chemical blowing agent which generates expansion gas during its decomposition. Additionally, further examples of low density foam substrates which may be used are described in greater detail in U.S. Pat. No. 6,245,267, commonly assigned, and which is incorporated herein by reference in its entirety.

In greater detail, the foam strip 4 may be formed from formulations comprising any of the following: polyvinylchloride, acrylo nitrile butadiene rubber, styrene butadione rubber, ethylene-propylene-diene rubber, polychloroprene, polyethylene, polypropylene or co-polymers of ethylene or propylene.

The prepolymer typically imparts the properties of tear and scratch resistance to the foam substrate and serves as the functional group attached to the monomer. In one embodiment, the prepolymer is a water soluble urethane and is attached to the monomer as a functional group. Example prepolymers include NeoRez® R-9649 available from NeoResins of Wilmington, Mass. and Cydrothan® HP 1035 available from Cytec Industries West Paterson, N.J. The water soluble prepolymers may be desired over solvent based prepolymer in consideration of environmental concerns given the toxicity of certain solvents.

The term “monomer” includes any suitable monomer or prepolymer. The monomers for use in the method and articles of the present invention may include vinyl, acrylic-based monomers, including those containing hydroxyl, carboxyl, allyl, or glycidyl functional groups. In one embodiment the monomer includes urethane acrylate.

Roofing Tiles

The roofing tiles 8 may be formed from foamed glass. One example of a suitable cellular ceramic material for the cellular ceramic segments is cellular glass formed by mixing pulverulent glass particles with a cellulating agent and forming a cellulatable glass batch as described in U.S. Pat. No. 3,354,024. The formulated glass may comprise, for example, conventional borosilicate or soda lime glass in crushed cullet form and the cellulating agent may comprise a carbonaceous material such as carbon black and the like. Other suitable cellular ceramic materials formed of a cellulatable siliceous composition are disclosed in U.S. Pat. No. 3,441,396.

The cellulatable glass batch is placed in a mold as, for example, a substantially rectangular mold. The cellulatable glass batch is then heated to cellulating temperature. At such temperature, the formulated glass particles soften and coalesce and the cellulating agent reacts to generate a gas and form individual closed cells within the block of cellular glass.

Adhesives

In choosing an adhesive for the adhesive layer 6 for securing the tiles 8, it is preferred that the adhesive will not melt or flow at the intended operating temperature or temperatures to which the roofing system will be subjected. The adhesive chosen should retain sufficient strength yet remain flexible at operating conditions. It is desirable that the hardness of the adhesive on the Shore A scale should be below 60 at 75° F. and preferably below 45. The adhesive should be compatible with the cellular ceramic material. The adhesive should be high in solid content, such content desirably being about 90% by weight with 95% by weight or higher preferred.

Examples of suitable adhesives are urethanes, silicones, or various epoxy adhesives. Certain silicone adhesives may be used where combustibility of the adhesive is objectionable or where stress corrosion of stainless steel could be a problem. Hotmelt adhesives may also be used as an adhesive up to temperatures where they will not flow or lose their strength. If hotmelt adhesives are employed, such as asphalt, coal tar or other bitumens, application should be limited to temperatures that are at least about 50° F. below the respective softening point of the hotmelt adhesive within the majority of the adhesive bulk.

Release Layer

The release layer 10 facilitates acceptable package, storage, and installation performance. The release system exhibits little or no affinity for the adhesive and exhibits no negative impact on the initial tackiness of the adhesive, and on the subsequent utility of the adhesive in application and long term performance. In addition, the release system permits ready manual separation of the shingles or tiles at ordinary ambient temperatures. Practically, the release layer 10 includes, for example, sheet materials including various films (i.e., cellophane, polyester, polypropylene, polyethylene, polyvinylalcohol and polyvinylchloride), paper, foil and the like which have been subjected to surface-treatment such as coating and/or impregnating with synthetic resins having high release properties (e.g., silicone resins and fluorocarbons). Additionally, release coatings (i.e., silicone resin and fluorine containing resins) can be directly applied to the shingle by conventional application methods (i.e., spray application).

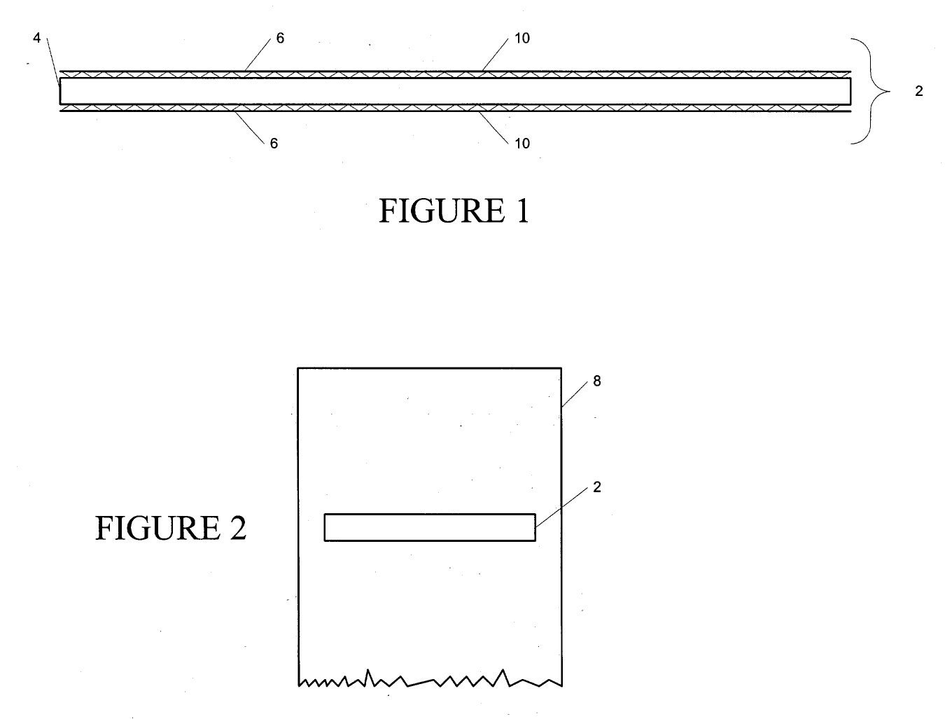

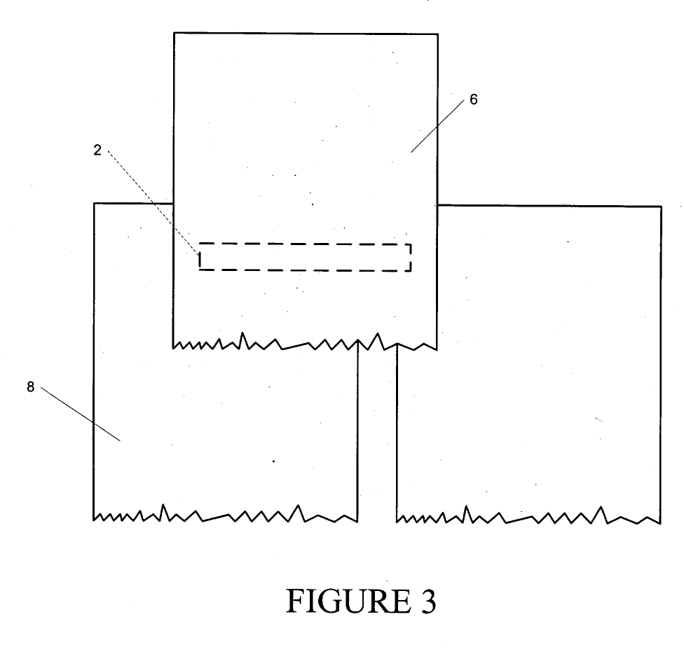

Turning now to the drawings, FIG. 1 illustrates the adhesive strip 2 having adhesive layers 6 residing on two opposed sides of the substrate 4. Additionally, an embodiment having release strip 10 residing on the adhesive layers 6 is illustrated. FIG. 2 illustrates a roofing tile 8 having the adhesive strip 2 attached to the tile 8. The adhesive strip may be placed in various locations on the tile 8. Additionally, the tile may be in the form of a single tile 8 as illustrated or in a sheet (not illustrated). FIG. 3 illustrates the roofing system comprising a plurality of tiles 8 adhered to each other by the adhesive strip 2. The adhesive strip 2 may be placed in various locations such that the tiles 8 may adhere to each other. The roofing system may comprise individual tiles 8 or sheets of tiles adhered by the adhesive strip 2.

It will be understood by those skilled in the art that while the present invention has been disclosed above with reference to certain embodiments, various modifications, changes and additions can be made to the foregoing invention, without departing from the spirit and scope thereof.

In the claims:

1. A roofing system comprising:
at least a first roofing tile and a second roofing tile;
an adhesive strip bonding the first and second roofing tiles, wherein the adhesive strip comprises a polymeric foam strip having a first side and a second side, and an adhesive residing on the first and second sides.

2. The roofing system of claim 1, wherein the roofing tile comprises a foamed glass material.

3. The roofing system of claim 1, wherein the adhesive includes a pressure sensitive adhesive, a hotmelt pressure sensitive adhesive or combinations thereof.

4. The roofing system of claim 1, wherein the polymeric foam strip is selected from the group consisting of polyvinylchloride, acrylo nitrile butadiene rubber, styrene butadione rubber, ethylene-propylene-diene rubber, polychloroprene, polyethylene, polypropylene, co-polymers of ethylene or propylene and combinations thereof.

5. The roofing system of claim 1, further including a release liner in communication with the adhesive residing on the first and second sides.

6. A roofing system comprising:
at least a first roofing tile and a second roofing tile;
an adhesive strip bonding the first and second roofing tile wherein the adhesive strip comprises a polymeric foam strip having a first side and a second sides, and a non-bituminous adhesive residing on the first and second side.

7. The roofing system of claim 6, wherein the roofing tile comprises a foamed glass material.

8. The roofing system of claim 6, wherein the adhesive includes a pressure sensitive adhesive, a hotmelt pressure sensitive adhesive or combinations thereof.

9. The roofing system of claim 6, wherein the polymeric foam strip is selected from the group consisting of polyvinylehloride, acrylo nitrile butadiene rubber, styrene butadione rubber, ethylene-propylene-diene rubber, polychloroprene, polyethylene, polypropylene, co-polymers of ethylene or propylene and combinations thereof.

10. The roofing system of claim 6, further including a release liner in communication with the adhesive residing on the first and second sides.

11. A roofing tile comprising:
an adhesive strip applied to a roofing tile, wherein the adhesive strip comprises a polymeric foam strip having a first side and a second side, and an adhesive layer residing on the first and second sides.

12. The roofing tile of claim 11, wherein the roofing tile comprises a foamed glass material.

13. The roofing tile of claim 11, wherein the adhesive includes a pressure sensitive adhesive, a hotmelt pressure sensitive adhesive or combinations thereof.

14. The roofing tile of claim 11, wherein the polymeric foam strip is selected from the group consisting of polyvinylchloride, acrylo nitrile butadiene rubber, styrene butadione rubber, ethylene-propylene-diene rubber, polychloroprene, polyethylene, polypropylene, co-polymers of ethylene or propylene and combinations thereof.

15. The roofing tile of claim 11, further including a release liner in communication with the adhesive residing on one side.

16. A method of forming a roofing system comprising:
providing at least a first roofing tile and a second roofing tile;
adhering the first and second roofing tiles together with an adhesive strip to bind the tile together, wherein the adhesive strip comprises a polymeric foam strip having a first side and a second side, and an adhesive applied to the first and second sides.

17. The method of forming a roofing system of claim 16, wherein the roofing tile comprises a foamed glass material.

18. The method of forming a roofing system of claim 16, wherein the adhesive includes a pressure sensitive adhesive, a hotmelt pressure sensitive adhesive or combinations thereof.

19. The method of forming a roofing system of claim 16, wherein the polymeric foam strip is selected from the group consisting of polyvinylchloride, acrylo nitrile butadiene rubber, styrene butadione rubber, ethylene-propylene-diene rubber, polychloroprene, polyethylene, polypropylene, co-polymers of ethylene or propylene and combinations thereof.

20. The method of forming a roofing system of claim 16, further including applying release liner in communication with the adhesive residing on the first and second sides.
